(19) United States
(12) Patent Application Publication
(10) Pub. No.: US 2018/0250644 A1
(43) Pub. Date: Sep. 6, 2018

(54) SYSTEMS AND METHODS FOR MIXING SUBSTANCES

(71) Applicant: DreaMau LLC, Baton Rouge, LA (US)

(72) Inventor: Quy That Ton, Baton Rouge, LA (US)

(73) Assignee: DreaMau LLC, Baton Rouge, LA (US)

(21) Appl. No.: 15/912,550

(22) Filed: Mar. 5, 2018

Related U.S. Application Data
(60) Provisional application No. 62/466,713, filed on Mar. 3, 2017.

(51) Int. Cl. B01F 9/00; B01F 9/10; B01F 13/04; B01F 13/10

(52) U.S. Cl. CPC B01F 9/0016; B01F 9/10; B01F 13/045; B01F 2215/0031; B01F 2009/0061; B01F 2009/0079; B01F 13/1022

(57) ABSTRACT

Mixer systems 200 are provided. A representative mixer system 200 includes a power circuit 105 that powers the mixer apparatus 200; a motor 110 that is electrically coupled and powered by the power circuit 105; and a rotating structure 115 that is mechanically coupled to the motor 110, which rotates the rotating structure 115. The rotating structure 115 includes container chambers 230a,b that a container 240a,b is aligned therein, wherein the rotation of the container 240a,b mixes substances that are contained in the container 240a,b to have a homogeneous or heterogeneous mixture.

### CROSS-REFERENCE TO RELATED APPLICATION

This application claims benefit to U.S. provisional patent application Ser. No. 62/466,713, filed on Mar. 3, 2017, which is incorporated by reference herein.

### TECHNICAL FIELD

The present disclosure is generally related to systems that mix substances and, more particularly, is related to systems and methods for mixing substances in containers.

### BACKGROUND

Even though there are thousands of nail polish colors and textures available, it is impossible to offer every combination. The typical method of formulating and mixing colors is to mix by hand. There are heretofore unaddressed needs with hand-mixing solutions.

### SUMMARY

Example embodiments of the present disclosure provide systems of mixing substances. Briefly described, in architecture, one example embodiment of the system, among others, can be implemented as follows: a motor; a rotating structure mechanically coupled to the motor, the rotating structure configured to rotate in a first direction with the motor; and at least one container holder mechanically coupled to the rotating structure, the at least one container holder configured to rotate in a second direction opposite from the first direction of the rotating structure.

Embodiments of the present disclosure can also be viewed as providing methods for mixing substances. In this regard, one embodiment of such a method, among others, can be broadly summarized by the following steps: providing a rotating structure mechanically coupled to a motor, the rotating structure comprising an outer main gear; operating the motor such that the rotating structure rotates in a first direction; and providing at least one container holder mechanically coupled to the rotating structure, the at least one container holder comprising a minor gear, the minor gear configured to interact with the outer main gear such that the at least one container holder rotates in a second direction opposite from the first direction.

Other systems, devices, methods, features of the invention will be or will become apparent to one skilled in the art upon examination of the following figures and detailed description. It is intended that all such systems, devices, methods, features be included within the scope of the invention, and be protected by the accompanying claims.

### BRIEF DESCRIPTION OF DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, the reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

FIG. 1 is a high-level block diagram of an example embodiment of a horizontal mixer system.

FIG. 2 is an exploded view of an example embodiment of a horizontal mixer system.

FIG. 3 is an exploded view of an example embodiment of an assembled horizontal mixer system.

FIG. 4 is a front, top, and right side view of an example embodiment of the horizontal mixer apparatus provided in FIG. 3.

FIG. 5 is a more detailed view of an example embodiment of a locking bar and a post of a horizontal mixer.

FIG. 6 is a front side view of an example embodiment of an assembled vertical mixer system.

FIG. 7 is a rear side view of an example embodiment of the assembled vertical mixer system of FIG. 6.

FIG. 8 is a front side view of an example embodiment of an opened assembled vertical mixer system.

FIG. 9 is a top side view of an example embodiment of an opened assembled vertical mixer system.

FIG. 10 is a front side view of an example embodiment of an opened assembled vertical mixer system.

FIG. 11 is a front side view of an example embodiment of an opened assembled vertical mixer system.

FIG. 12 is an exploded view of an example embodiment of the assembled vertical mixer system of FIG. 8.

FIG. 13 is an exploded view of an alternative embodiment of the assembled vertical mixer system of FIG. 8.

FIG. 14 is an exploded view of an alternative embodiment of the assembled vertical mixer system of FIG. 8.

FIGS. 15A, 15B, and 15C are system views of inserting a larger container into a vertical mixer.

FIGS. 16A, 16B, and 16C are system views of inserting a slim container into a vertical mixer.

FIG. 17 is a flow diagram of an example embodiment of a method of mixing substances.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Mixer systems are provided. A representative mixer apparatus includes a power circuit that powers the mixer apparatus; a motor that is electrically coupled and powered by the power circuit; and a rotating structure that is mechanically coupled to the motor, which rotates the rotating structure. The rotating structure includes container chambers that a container is aligned therein, wherein the rotation of the container mixes substances that are contained in the container to have a homogeneous or heterogeneous mixture.

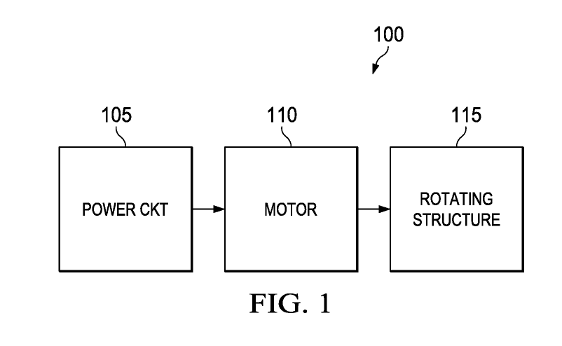

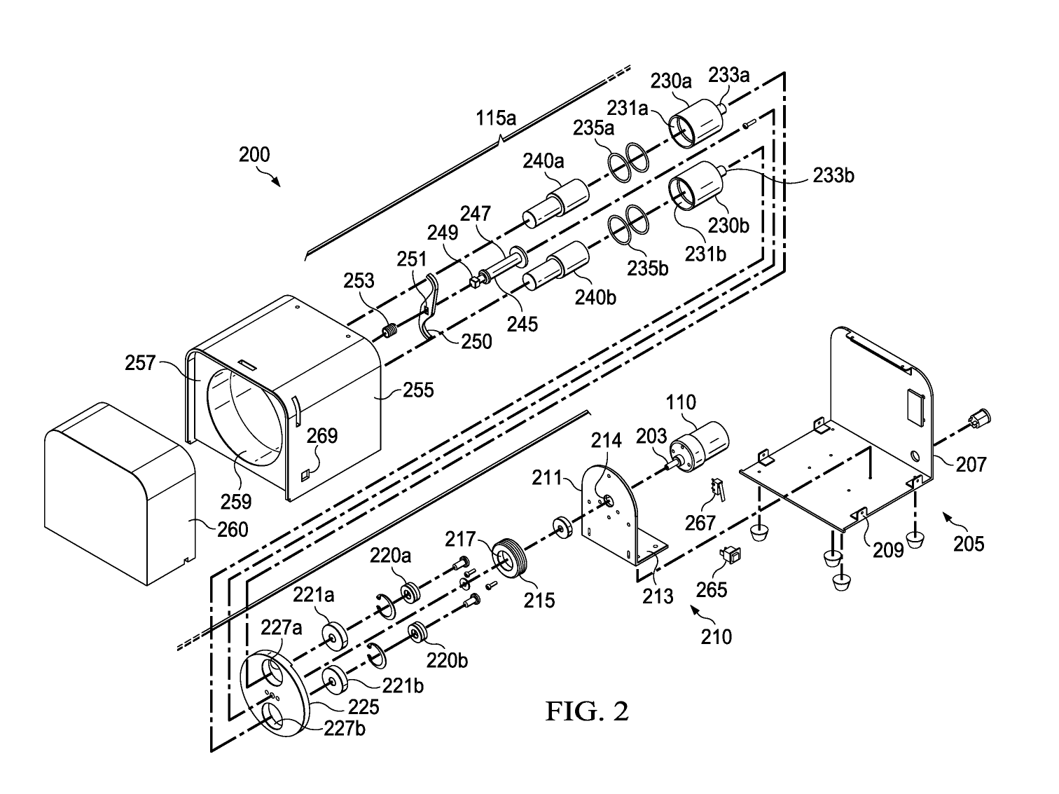

FIG. 1 is a high-level block diagram of horizontal mixer 100 in accordance with an example embodiment of the present disclosure. Horizontal mixer 100 includes power circuit 105 that is electrically coupled and powers motor 110. Rotating structure 115 is mechanically coupled to motor 110, which rotates the rotating structure having a container containing substance. The rotation of the container mixes the substance to have a homogeneous or heterogeneous mixture. Horizontal mixer 100 is further illustrated and described in connection with FIGS. 2-5.

FIG. 2 is an exploded view of horizontal mixer 200 that illustrates an example embodiment of horizontal mixer 100 shown in FIG. 1. In this example embodiment, the architecture of horizontal mixer 200 of FIG. 2 is similar to the architecture of horizontal mixer 100 described in FIG. 1. Like features are labeled with the same reference numbers, such as motor 110 and rotating structure 115. FIG. 2 illustrates an example embodiment of rotating structure 115 in more detail.

Horizontal mixer 200 includes mounting platform 205 having sidewall 207 and bottom wall 209. Sidewall 207 and bottom wall 209 form a rear wall and a bottom wall of horizontal mixer 200, respectively. Mounting bracket 210 includes sidewall 211 and bottom wall 213. Bottom wall 213 of mounting bracket 210 is attached to bottom wall 209 of mounting platform 205. Sidewall 211 includes motor hole 214 that shaft 203 of motor 110 is placed there through. Screws can be used to secure motor 110 onto sidewall 211 of mounting bracket 210. Motor 110 rotates shaft 203 that is attached to main gear 215, which rotates with shaft 203. Main gear 215 includes shaft hole 217 that shaft 203 is placed there through.

Container holders 230a,b are placed in container holes 227a,b of rotating housing 225. Each container holder 230a,b includes container chamber 231a,b and minor gear shaft 233a,b. Minor gear shafts 233a,b are placed through rotating couplings 221a,b and are attached to minor gears 220a,b via screws, respectively.

In an example embodiment, rings 235a,b are placed on the inner surface of container holders 230a,b and may be made of a rubber material that engages containers 240a,b to facilitate rotating them. Rotating housing 225 that is assembled with minor gears 220a,b, rotating couplings 221a,b, and container holders 230a,b is attached to motor shaft 203. The attachment between motor shaft 203 and rotating housing 225 results in the engagement of main gear 215 and minor gears 220a,b. Motor 110 rotates shaft 203, which in turn rotates main gear 215, which in turn rotates minor gears 220a,b, and in turn rotates container holders 230a,b and rotating housing 225.

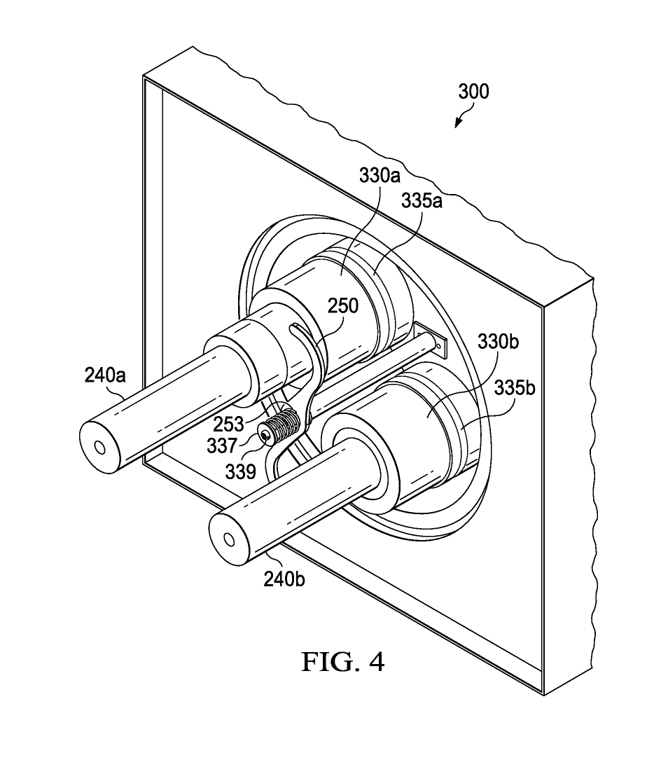

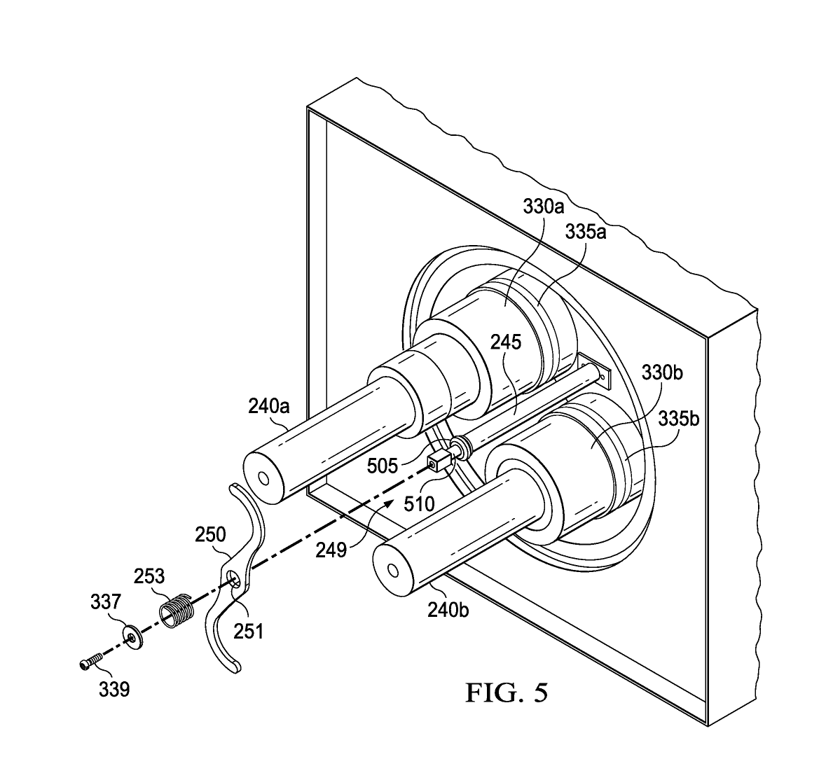

Distal end 247 of post 245 may be attached at a center of rotating housing 225 via screws. Proximal end 249 of post 245 may be mechanically coupled to locking bar 250, which may be in an “S” shape, for example, and includes locking hole 251. Proximal end 249 of post 245 may be placed through locking hole 251 of locking bar 250. Spring 253 is placed at proximal end 249 of post 245 to facilitate pushing locking bar 250 towards distal end 247 of post 245. Locking bar 250 may turn counter clockwise to lock containers 240a,b onto container holders 230a,b. More details of post 245 and locking bar 250 are described and shown in connection to FIGS. 4 and 5.

Mixer housing 255 houses motor 110 and rotating structure 115 and is attached to mounting platform 205. Front wall 257 of mixer housing 255 includes mixer access opening 259 through which container holders 230a,b can be accessed. A user may place container 240a,b through mixer access opening 259 and into container holders 230a,b. Front cover 260 covers mixer access opening 259 to prevent the user from touching rotating containers 240a,b when mixer 200 is being used. In an example embodiment, mixer housing 255 includes a power button aperture 269 on a side wall of mixer housing 255, which allows power button 265 to be placed there through. Electrical wiring 267 electrically couples power button 265 to motor 110 and a power circuit (not shown). Power button 265 connects and disconnects the power circuit from the motor. The power circuit may be connected to an electrical outlet (not shown).

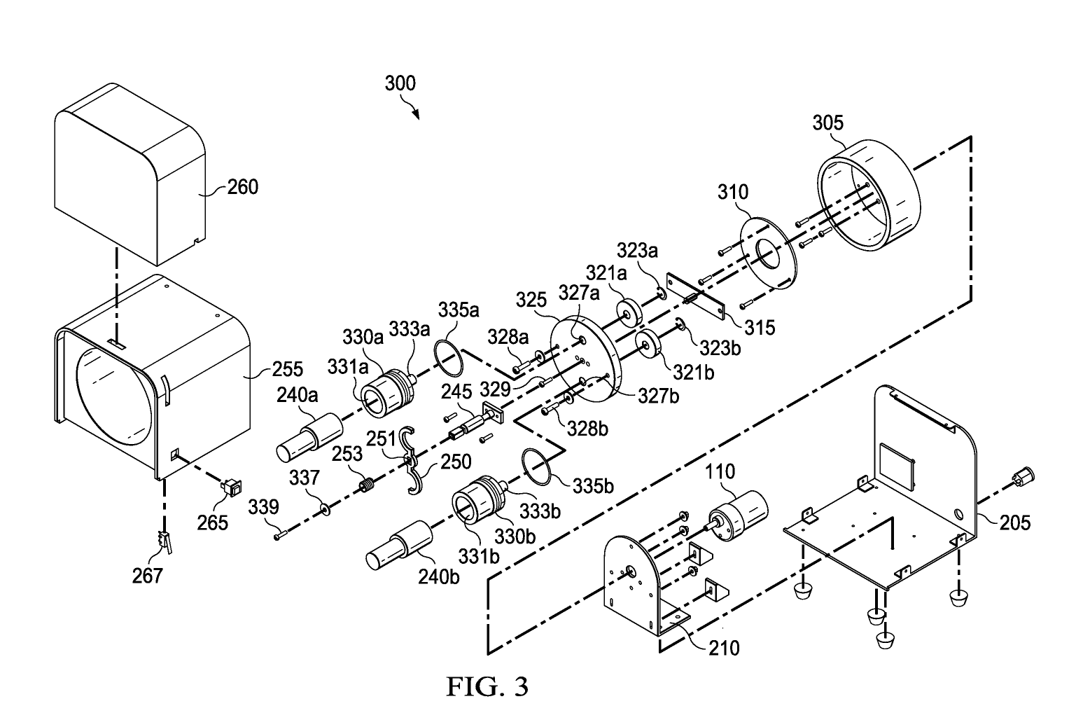

FIG. 3 is an exploded view of horizontal mixer 300 in accordance with another embodiment of the present disclosure. In this example, the architecture of horizontal mixer 300 of FIG. 3 is similar to the architecture of horizontal mixer 300 as described in FIG. 2. Like features are labeled with the same reference numbers, such as motor 110, containers 240a,b, mounting platform 205, mounting bracket 210, locking bar 250, locking hole 251, spring 253, mixer housing 255, front cover 260, power button 265, and electrical wiring 267.

Horizontal mixer 300 includes stationary chamber 305 that is attached to mounting bracket 210 via screws. Chamber washer 310 is attached inside stationary chamber 305. Container holders 330a,b are attached to rotating housing 325. Each container holder 330a,b includes container chamber 331a,b and holder shaft 333a,b. Rotating housing 325 includes shaft holes 327a,b that receive holder shafts 333a,b there through. Rotating couplings 321a,b are positioned between rotating housing 325 and rotating bracket 315. Rotating couplings 321a,b include holes that receive holder shafts 333a,b. Container holders 330a,b are attached to rotating housing 325 and rotating couplings 321a,b by way of o-rings 323a,b that clamp onto holder shafts 333a,b.

In an example embodiment, rotating bracket 315 is attached to rotating housing 325 via screws 328a,b. Attached rotating bracket 315, rotating housing 325, and container holders 330a,b are attached to motor 110 via screw 329. Rings 335a,b are positioned around the cylindrical body of container holders 330a,b. Rings 335a,b may be made of rubber that engages the inner surface of stationary chamber 305 such that container holders 330a,b rotate with respective holder shafts 333a,b as rotating housing 325 rotates with the motor shaft.

In this example embodiment, locking bar 250 is mechanically coupled to post 245 via spring 253, washer 337, and screw 339 that screws onto post 245. More details of post 245 and locking bar 250 are described and shown in connection to FIGS. 4 and 5.

FIG. 4 is a front, top, and right side view of assembled example embodiment of horizontal mixer 300 shown in FIG. 3. In this example embodiment, locking bar 250 is in an unlocking position. Container 240b is completely inserted into container holder 330b and container 240a is partially inserted into container holder 330a. Locking bar 250 can rotate counter clockwise to engage or lock containers 240a,b in place. The locking bar can rotate clockwise to disengage or unlock containers 240a,b from locking bar 250.

FIG. 5 is a more detailed view of an example embodiment of locking bar 250 and post 245 of horizontal mixer 300. Locking bar 250 includes locking hole 251, which is substantially in the shape of a rectangle. Stop washer 505 positions locking bar 250 at a predetermined location of post 245 preventing locking bar 250 from sliding further toward distal end 247 of post 245. Proximal end 249 of post 245 may be substantially in the shape of a rectangle and include recess section 510 that allows locking bar 250 to rotate about post 245; hence enabling locking bar 250 to lock or unlock containers 240a,b. Locking hole 251 of locking bar 250 is slightly larger than proximal end 249 of post 245 to more easily slide locking bar 250 toward stop washer 505, to more easily rotate about recess section 510, and to engage proximal end 249 at stop washer 505.

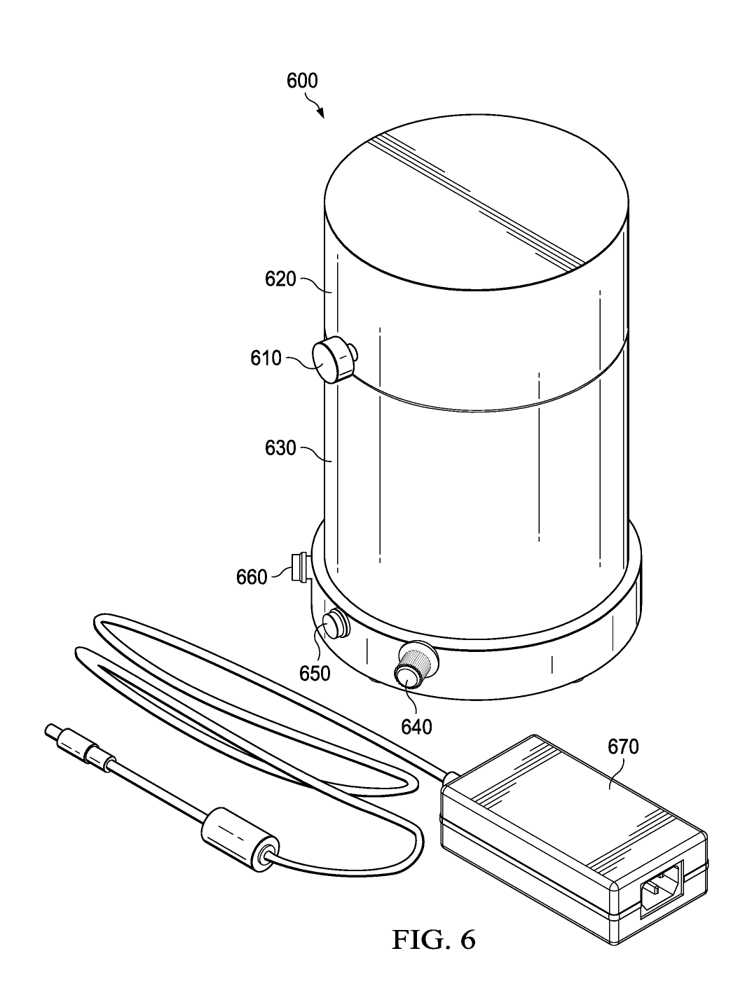

FIG. 6 provides a system diagram of vertical mixer 600. Although two example embodiments (vertical and horizontal) are presented herein, features of either may be interchangeable. A disclosed feature of the vertical mixer may be used on the horizontal mixer and a disclosed feature of the horizontal mixer may be used on the vertical mixer. Vertical mixer 600 of FIG. 6 includes lid 620, latch 610, base 630, timer control 640, start button 650, stop button 660, and power supply 670. Latch 610 locks lid 620 in place. In this example embodiment, turning latch 610 enables the locking and unlocking of lid 620. Start button 650 is pressed to start vertical mixer 600. Stop button 660 is pressed to stop vertical mixer 600. Timer control 640 controls the length of time that vertical mixer 600 operates. In an example embodiment, timer 640 can be set to 1 minute, 2 minutes, or 3 minutes. In an alternative embodiment, an analog variable timer control may be used. Digital timers are also possible embodiments. Power supply 670 supplies power to vertical mixer 600 as received from a wall outlet.

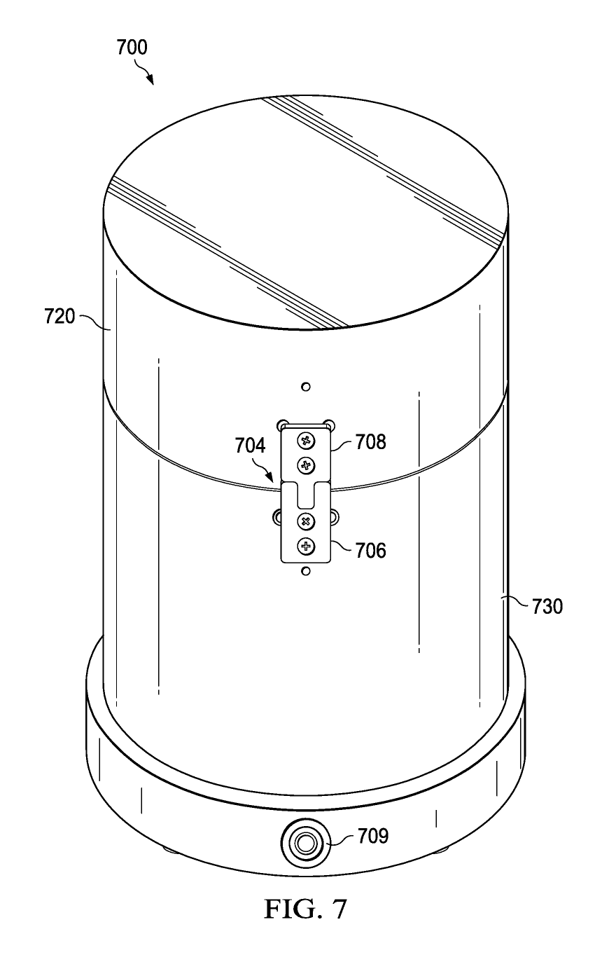

FIG. 7 provides a rear view of an example embodiment of vertical mixer 700. Hinge 704 connects lid 720 and base 730 such that lid 720 swings open on the horizontal axis formed between upper hinge plate 708 and lower hinge plate 706. Power port 709 receives power supply 670 of FIG. 6 to receive power for vertical mixer 700.

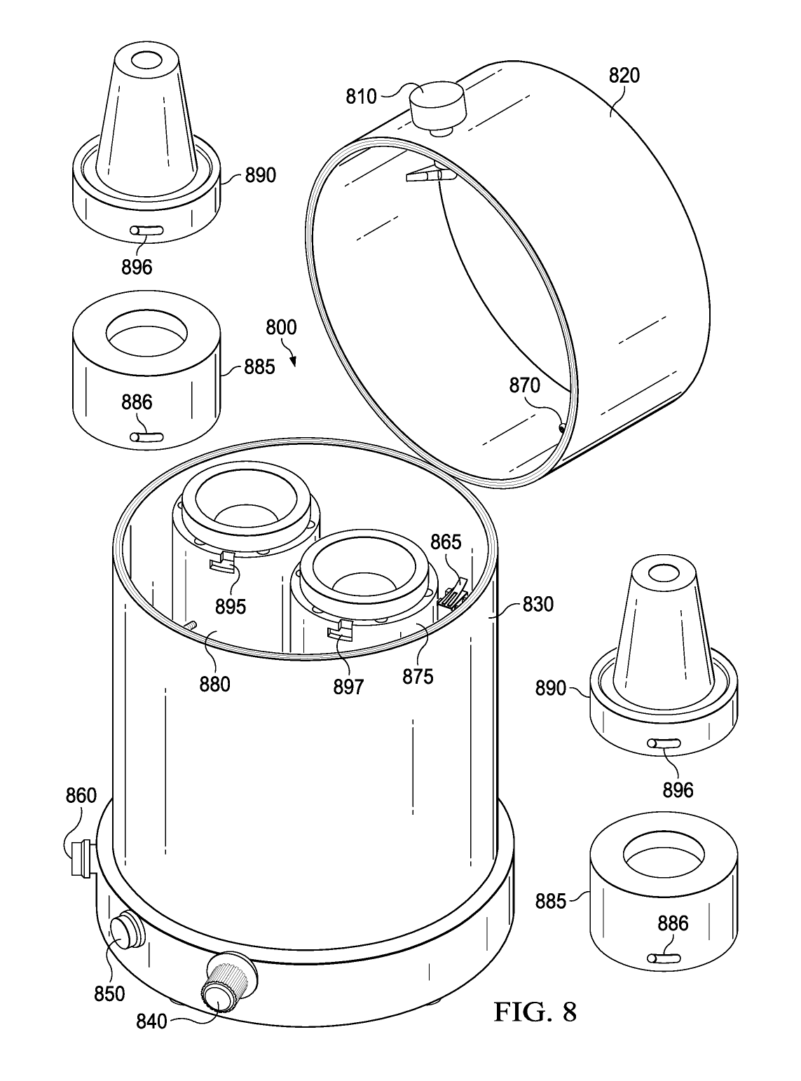

FIG. 8 provides a view of an example embodiment of vertical mixer 800 with the lid open. Vertical mixer 800 includes lid 820, latch 810, base 830, timer control 840, start button 850, stop button 860, safety switch 865, and container holders 875, 880. Latch 810 locks lid 820 in place. In this example embodiment, turning latch 810 enables the locking and unlocking of lid 820. Start button 850 is pressed to start vertical mixer 800. Stop button 860 is pressed to stop vertical mixer 800. Timer control 840 controls the length of time that vertical mixer 800 operates. Safety switch 865 closes when in contact with lid safety contact 870. If lid 820 opens during operation and lid safety contact 870 loses contact with safety switch 865, the operation of vertical mixer 800 ceases. Operation of vertical mixer 800 is only possible if safety switch 865 is depressed or closed.

In operation, container holders 875, 880 rotate around a central vertical axis of vertical mixer 800. Additionally, each container holder 875, 880 rotates around its own center vertical axis. In an example embodiment, the rotation around the central vertical mixer axis is opposite of the rotation around the container holder center vertical axis. That is, if container holders 875, 880 are rotating around the vertical mixer center axis in a clockwise direction, then container holders 875, 880 are spinning around their container holder center axes in a counterclockwise direction. In an alternative embodiment, both rotations are in the same direction, whether clockwise or counterclockwise.

Container holder caps 885, 890 keep bottles in place during the operation of vertical mixer 800. Container holder caps 885 are open type in which the top of a bottle may extend through the hole in the top of container holder cap 885. Container holder caps 890 are closed type in which the bottle is entirely enclosed by container holder cap 890. Each of container holder caps 885, 890 comprise nibs 886, 896 in the side of the container holder cap. Nibs 886, 896 slide down and rotate into slots 897, 895 of container holders 875, 880. This locks container holder caps 885, 890 in place thereby securing the bottles during operation of vertical mixer 800.

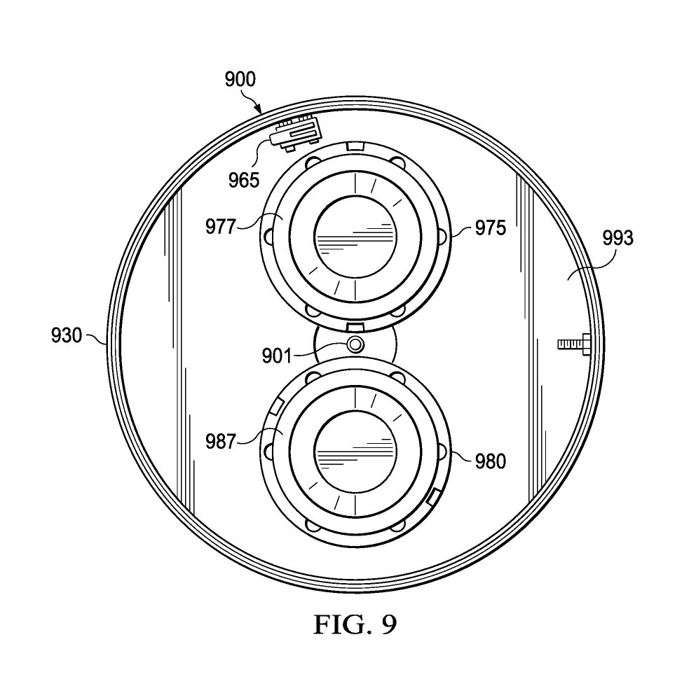

FIG. 9 provides a top perspective looking down into an example embodiment of base 930 of vertical mixer 900. Vertical mixer 900 includes base 930, rotating housing 993, safety switch 965, container holders 975, 980, container holder inserts 977, 987, and center axis 901. Rotating housing 993 rotates about center axis 901. As rotating housing 993 rotates around center axis 901, container holders 975, 980 rotate about center axis 901. Container holders 975, 980 also rotate about their own respective center axes. Container holders 975, 980 also comprise container holder inserts 977, 987 that receive containers or bottles that contain substances to be mixed.

In an example embodiment, the rotation around the center axis 901 is opposite of the rotation around the container holder center vertical axis. That is, if container holders 975, 980 are rotating around the center axis 901 in a clockwise direction, then container holders 975, 980 are spinning around their container holder center axes in a counterclockwise direction. In an alternative embodiment, both rotations are in the same direction, whether clockwise or counterclockwise.

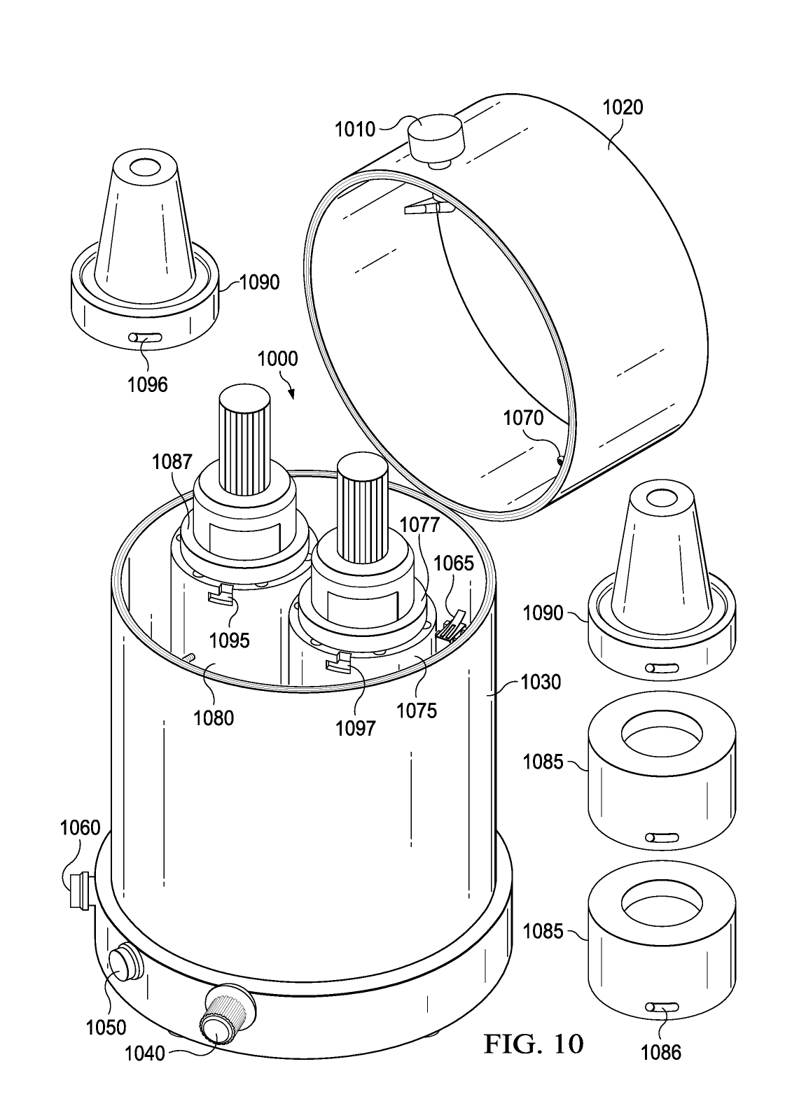

FIG. 10 provides a diagram of an example embodiment of the vertical mixer of FIG. 8 with containers/bottles inserted. Vertical mixer 1000 includes lid 1020, latch 1010, base 1030, timer control 1040, start button 1050, stop button 1060, safety switch 1065, and container holders 1075, 1080. Latch 1010 locks lid 1020 in place. In this example embodiment, turning latch 1010 enables the locking and unlocking of lid 1020. Start button 1050 is pressed to start vertical mixer 1000. Stop button 1060 is pressed to stop vertical mixer 1000. Timer control 1040 controls the length of time that vertical mixer 1000 operates. Safety switch 1065 closes when in contact with lid safety contact 1070. If lid 1020 opens during operation and lid safety contact 1070 loses contact with safety switch 1065, the operation of vertical mixer 1000 ceases. Operation of vertical mixer 1000 is only possible if safety switch 1065 is depressed or closed.

In operation, container holders 1075, 1080 rotate around a central vertical axis of vertical mixer 1000. Additionally, each container holder 1075, 1080 rotates around its own center vertical axis. In an example embodiment, the rotation around the central vertical mixer axis is opposite of the rotation around the container holder center vertical axis. That is, if container holders 1075, 1080 are rotating around the vertical mixer center axis in a clockwise direction, then container holders 1075, 1080 are spinning around their container holder center axes in a counterclockwise direction. In an alternative embodiment, both rotations are in the same direction, whether clockwise or counterclockwise.

Container holders 1075, 1080 comprise container holder inserts 1077, 1087 into which container/bottles are placed. Container holder inserts 1077, 1087 apply tension to the containers/bottles when container holder caps 1085, 1090 are applied.

Container holder caps 1085, 1090 keep bottles in place during the operation of vertical mixer 1000. Container holder caps 1085 are open type in which the top of a bottle may extend through the hole in the top of container holder cap 1085. Container holder caps 1090 are closed type in which the bottle is entirely enclosed by container holder cap 1090. Each of container holder caps 1085, 1090 comprise nibs 1086, 1096 in the side of the container holder cap. Nibs 1086, 1096 slide down and rotate into slots 1097, 1095 of container holders 1075, 1080. This locks container holder caps 1085, 1090 in place thereby securing the bottles during operation of vertical mixer 1000.

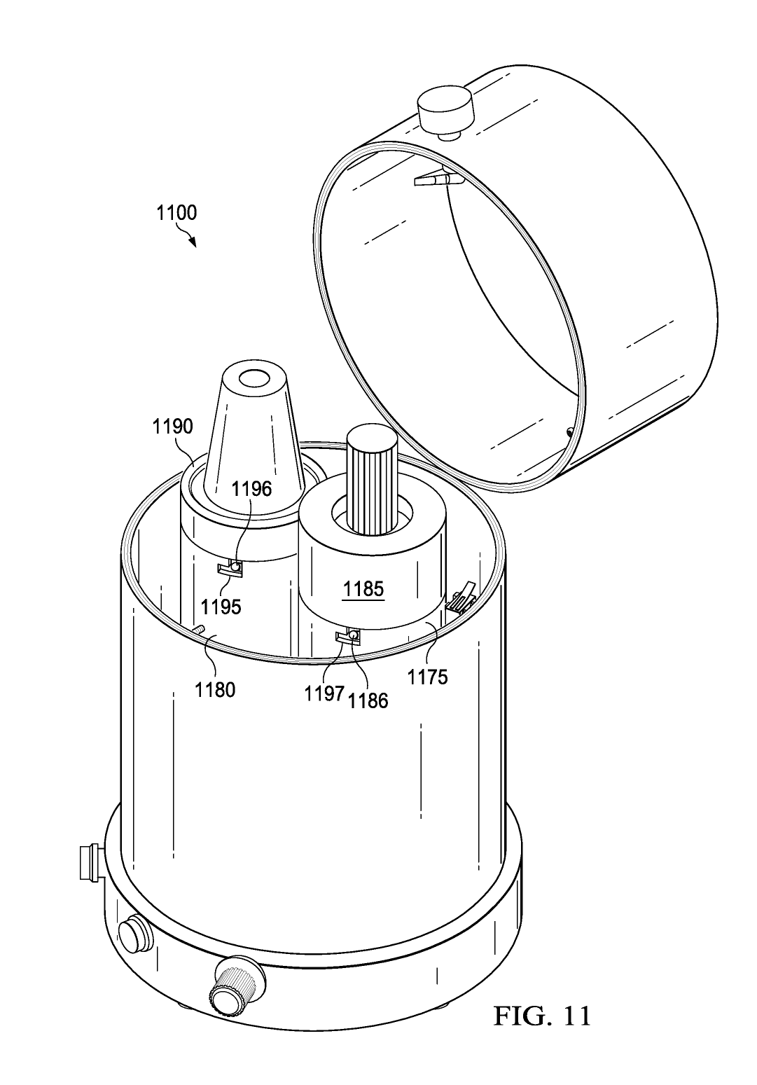

FIG. 11 provides a diagram of an example embodiment of vertical mixer 1100 with bottles inserted and container holder caps 1185, 1190 in place. With containers/bottles inserted in container holders 1175, 1180, container holder caps 1185, 1190 are applied with nibs 1186, 1196 inserted into slots 1197, 1195.

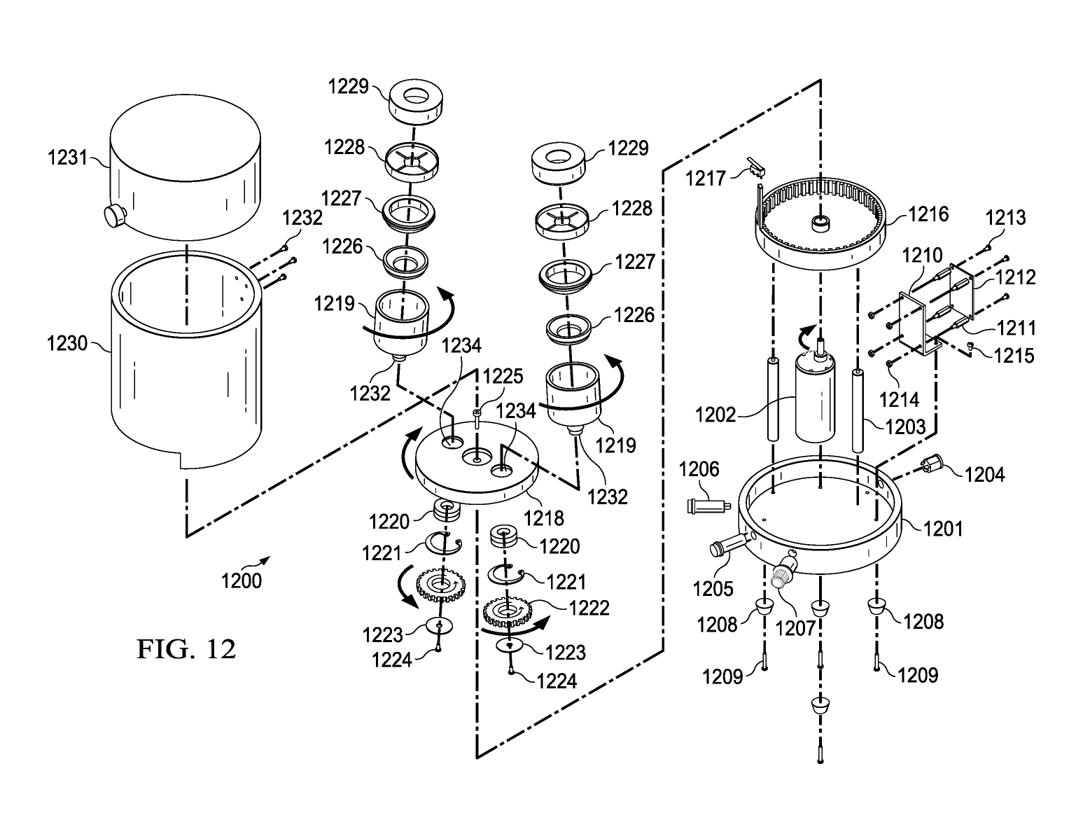

FIG. 12 provides an exploded diagram of an example embodiment of vertical mixer 1200. Vertical mixer 1200 includes base holder 1201 having power input port 1204, start button 1205, stop button 1206, and timer control 1207. Inner mounting brackets 1210 and outer mounting bracket 1212 support power input port 1204. Inner mounting bracket 1210 and outer mounting bracket 1212 are connected with screws 1214, spacers 1211, and screws 1213. Inner mounting bracket 1210 is attached to base holder 1201 with screws 1215. Base feet 1208 are attached to base holder 1201 with screws 1209. Motor 1202 is attached to base plate 1201 and the shaft of motor 1202 is attached through the middle of main gear 1216 such that main gear 1216 turns with the rotation of the shaft of motor 1202. Supports 1203 support main gear 1216 inside base 1230.

Container holders 1219 include container holder shafts 1232 that extend through holes 1234 of rotating housing 1218. Container holders 1219 are attached to rotating housing with rotating couplings 1220 and o-rings 1221 to minor gears 1222 and attached with washers 1223 and screws 1224. Rotating housing 1218 is attached to main gear 1216 and the shaft of motor 1202 with screw 1225. As main gear 1216 rotates clockwise with the shaft of motor 1202, minor gears 1222 (and container holders 1219) turn counterclockwise.

Container holders 1219 include lower container insert 1226 held in place with container holder screw down 1227. Upper container holder insert 1228 holds a container/bottle in place in container holder 1219 and container holder cap 1229. Lid 1231 is connected to base 1230 with a hinge by screws 1232. Safety switch 1217 enables the turning of the shaft of motor 1202 when lid 1231 is closed onto base 1230.

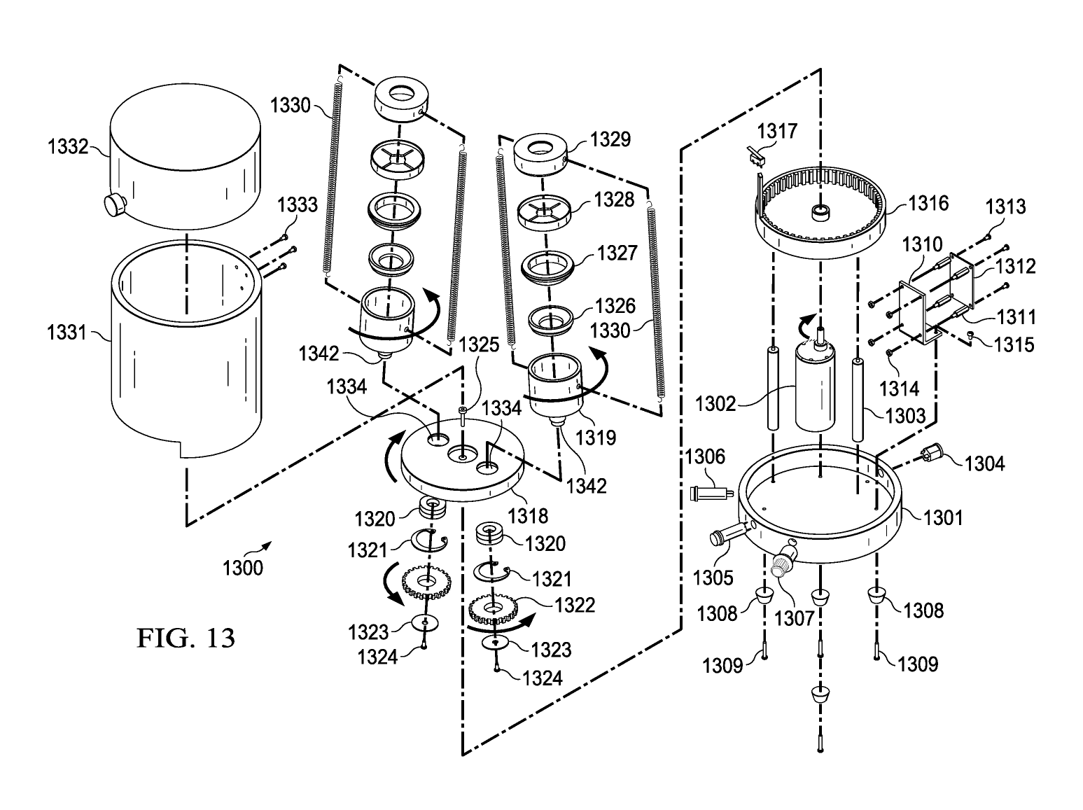

FIG. 13 provides an exploded diagram of an example embodiment of vertical mixer 1300 with outer springs. Vertical mixer 1300 includes base holder 1301 having power input port 1304, start button 1305, stop button 1306, and timer control 1307. Inner mounting brackets 1310 and outer mounting bracket 1312 support power input port 1304. Inner mounting bracket 1310 and outer mounting bracket 1312 are connected with screws 1314, spacers 1311, and screws 1313. Inner mounting bracket 1310 is attached to base holder 1301 with screws 1315. Base feet 1308 are attached to base holder 1301 with screws 1309. Motor 1302 is attached to base plate 1301 and the shaft of motor 1302 is attached through the middle of main gear 1316 such that main gear 1316 turns with the rotation of the shaft of motor 1302. Supports 1303 support main gear 1316 inside base 1331.

Container holders 1319 include container holder shafts 1332 that extend through holes 1334 of rotating housing 1318. Container holders 1319 are attached to rotating housing with rotating couplings 1320 and o-rings 1321 to minor gears 1322 and attached with washers 1323 and screws 1324. Rotating housing 1318 is attached to main gear 1316 and the shaft of motor 1302 with screw 1325. As main gear 1316 rotates clockwise with the shaft of motor 1302, minor gears 1322 (and container holders 1319) turn counterclockwise.

Container holders 1319 include lower container insert 1326 held in place with container holder screw down 1327. Upper container holder insert 1328 holds a container/bottle in place in container holder 1319 and container holder cap 1329. Holder caps 1329 are held down to container holders 1319 with outer springs 1330. Lid 1332 is connected to base 1331 with a hinge by screws 1333. Safety switch 1317 enables the turning of the shaft of motor 1302 when lid 1332 is closed onto base 1331.

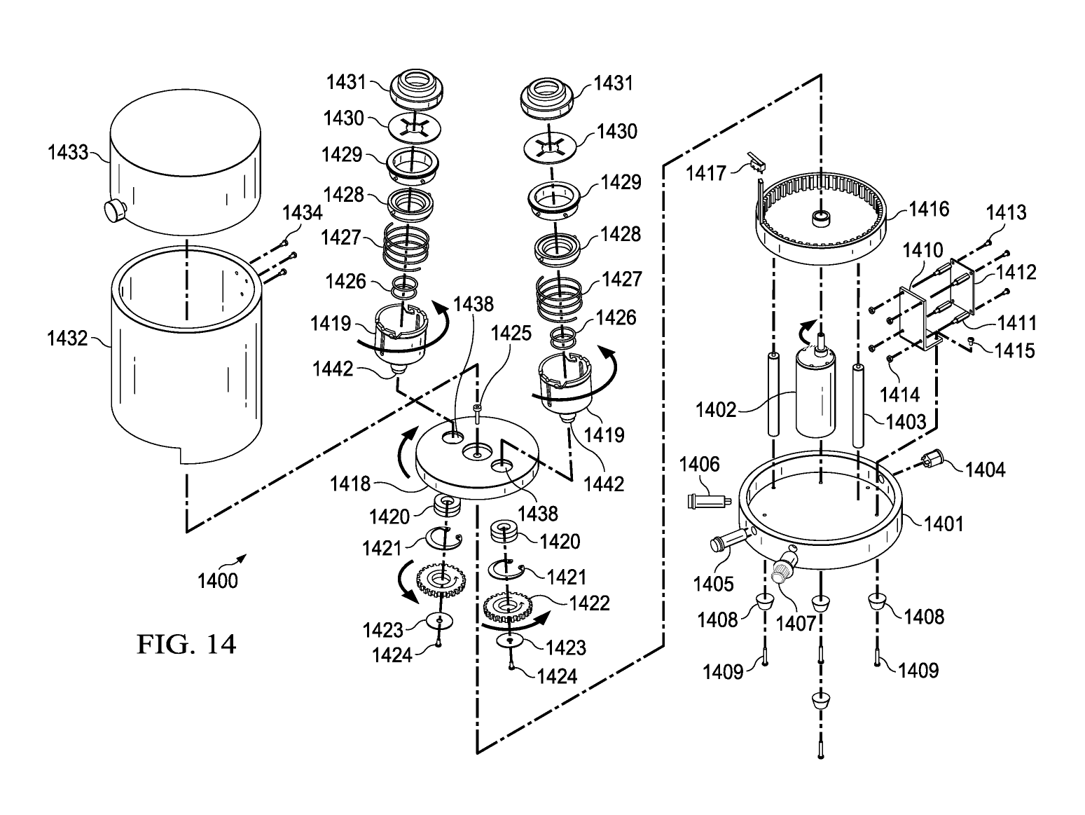

FIG. 14 provides an exploded diagram of an example embodiment of vertical mixer 1400 with inner springs. Vertical mixer 1400 includes base holder 1401 having power input port 1404, start button 1405, stop button 1406, and timer control 1407. Inner mounting brackets 1410 and outer mounting bracket 1412 support power input port 1404. Inner mounting bracket 1410 and outer mounting bracket 1412 are connected with screws 1414, spacers 1411, and screws 1413. Inner mounting bracket 1410 is attached to base holder 1401 with screws 1415. Base feet 1408 are attached to base holder 1401 with screws 1409. Motor 1402 is attached to base plate 1401 and the shaft of motor 1402 is attached through the middle of main gear 1416 such that main gear 1416 turns with the rotation of the shaft of motor 1402. Supports 1403 support main gear 1416 inside base 1432.

Container holders 1419 include container holder shafts 1432 that extend through holes 1434 of rotating housing 1418. Container holders 1419 are attached to rotating housing with rotating couplings 1420 and o-rings 1421 to minor gears 1422 and attached with washers 1423 and screws 1424. Rotating housing 1418 is attached to main gear 1416 and the shaft of motor 1402 with screw 1425. As main gear 1416 rotates clockwise with the shaft of motor 1402, minor gears 1422 (and container holders 1419) turn counterclockwise.

Container holders 1419 include lower container insert 1428 connected to container holder 1419 with outer spring 1427 and containing inner spring 1426. Containers/bottles fit within outer spring 1427 and sit on inner spring 1426. Container holder cap 1431 tops the container/bottles and connects to container holders 1419 with a nib on container holder cap 1431 inserted in a slot in container holder 1419. Lid 1433 is connected to base 1432 with a hinge by screws 1434. Safety switch 1417 enables the turning of the shaft of motor 1402 when lid 1433 is closed onto base 1432.

In an example embodiment, there is a hole at the bottom on the inside of the container holders 1419 so that outer spring 1427 from lower insert 1428 locks into place in container holder 1419. There is also a hole in lower insert 1428 at the top end of outer spring 1427 to hold spring 1427 to lower insert 1428. Lower insert 1428 is positioned with hold spring 1427 down into container holder 1419. The containers/bottles are then placed into lower insert 1428 and then container holder cap 1431 is placed over the containers/bottles. The outside motion of a clockwise motion and the inside motion of a counter-clockwise motion has the bottles simultaneously turning around one axis in a counter-clockwise motion and around another axis in a clockwise motion.

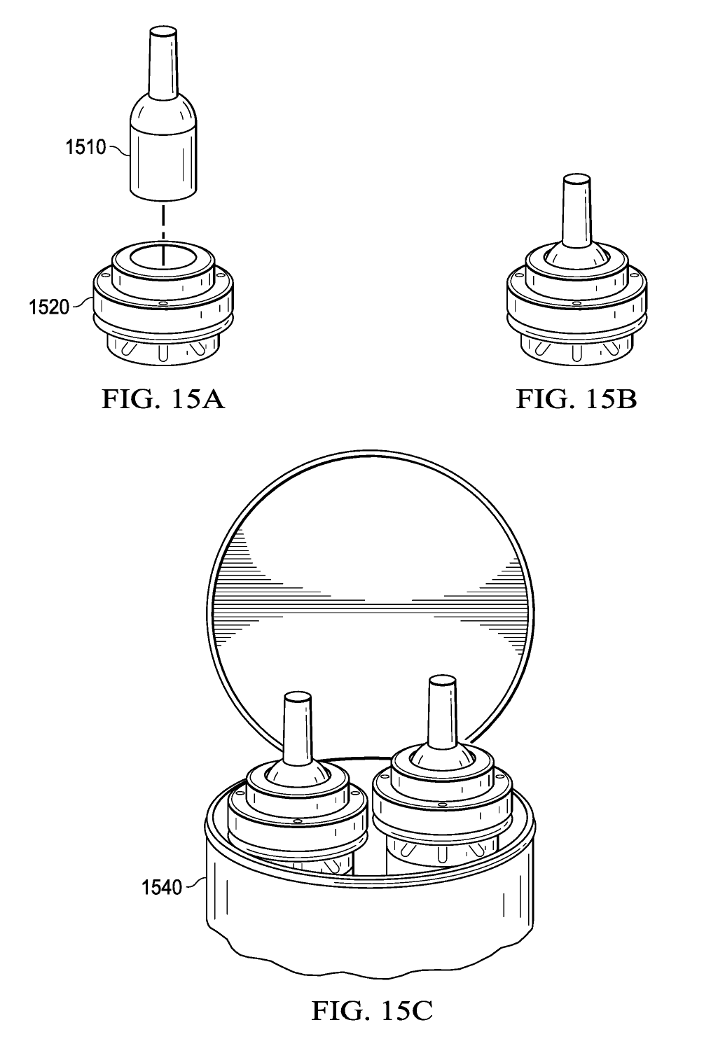

FIGS. 15A, 15B, and 15C provide system drawings of an example embodiment of larger container/bottle 1510 set into container holder 1520 inside base 1540 of the vertical mixer.

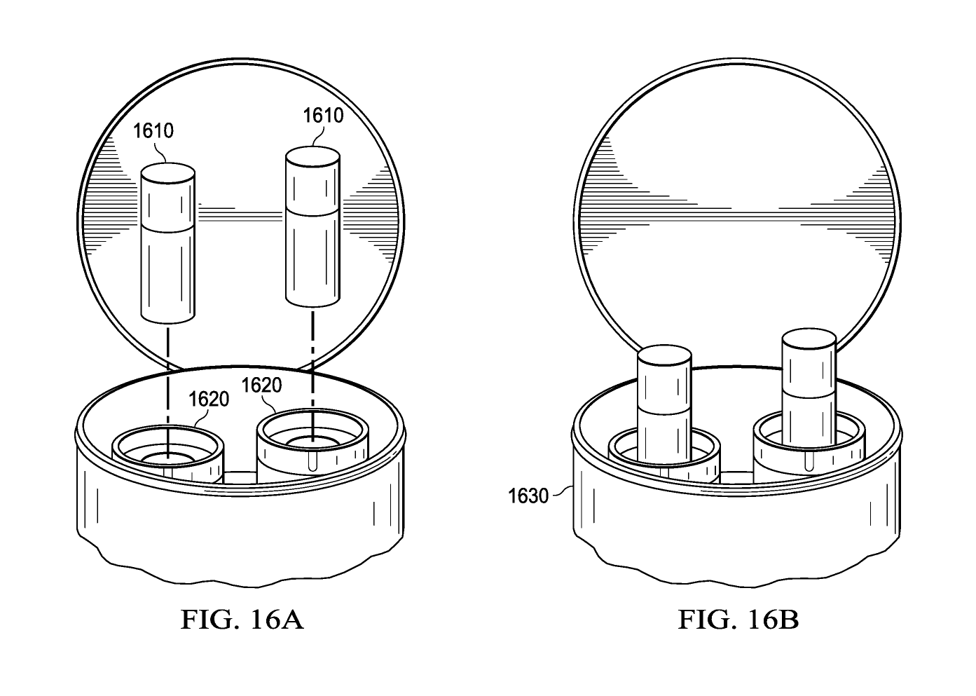

FIGS. 16A, 16B, and 16C provide system drawings of an example embodiment of slim container/bottle 1610 set into container holder 1620 inside base 1630 of the vertical mixer.

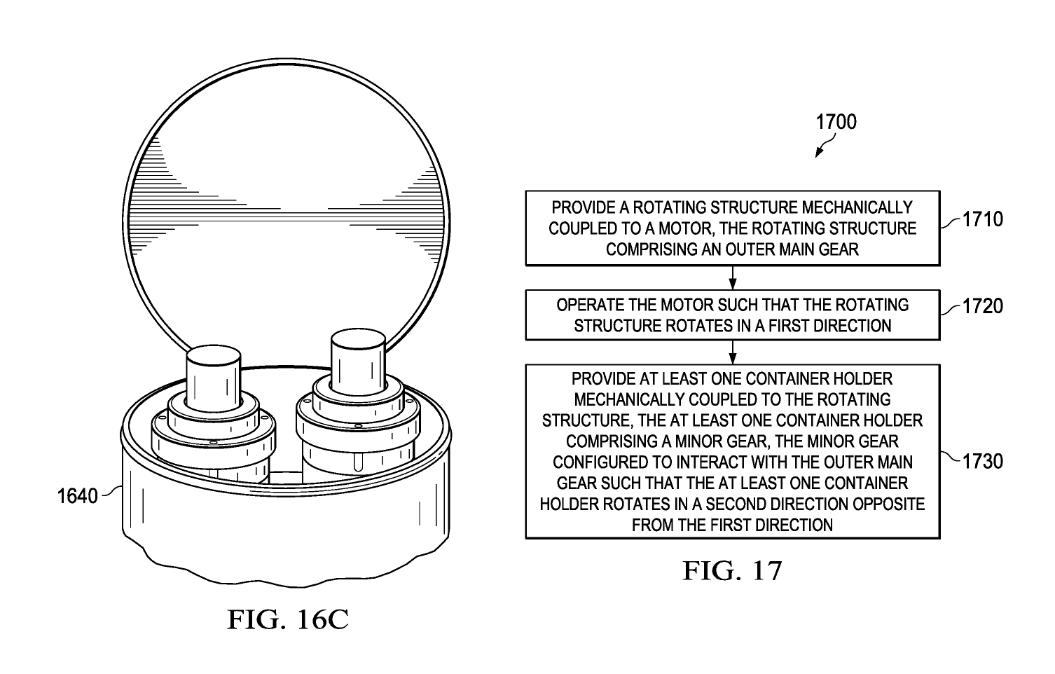

FIG. 17 provides flow diagram 1700 of a method of mixing substances. In block 1710, a rotating structure with an outer main gear is provided. The rotating structure is coupled to a motor. In block 1720, the motor is operated such that the rotating structure rotates in a first direction. In block 1730, at least one container holder mechanically coupled to the rotating structure is provided. The at least one container holder comprises a minor gear configured to interact with the outer main gear such that the at least one container holder rotates in a second direction opposite from the first direction.

Although example embodiments of the mixers disclosed herein are described with two containers/bottles, 1, 2, 3, and more bottles may be similarly designed for. Additionally, though the mixers disclosed herein are described in terms of mixing nail polish, other substances may likewise be mixed using the disclosed mixers.

This description has been presented for purposes of illustration and description. It is not intended to be exhaustive or to limit the disclosure to the precise forms disclosed. Obvious modifications or variations are possible in light of the above teachings. The embodiments discussed, however, were chosen to illustrate the principles of the disclosure, and its practical application. The disclosure is thus intended to enable one of ordinary skill in the art to use the disclosure, in various embodiments and with various modifications, as are suited to the particular use contemplated. All such modifications and variation are within the scope of this disclosure, as determined by the appended claims when interpreted in accordance with the breadth to which they are fairly and legally entitled.

Therefore, having thus described the disclosure, at least the following is claimed:

1. A mixer system comprising:
a motor;
a rotating structure mechanically coupled to the motor, the rotating structure configured to rotate in a first direction with the motor; and
at least one container holder mechanically coupled to the rotating structure, the at least one container holder configured to rotate in a second direction opposite from the first direction of the rotating structure.

2. The mixer system of claim 1, wherein the first direction is clockwise and the second direction is counterclockwise.

3. The mixer system of claim 1, further comprising a safety switch configured to enable rotation when the safety switch is closed.

4. The mixer system of claim 3, wherein the safety switch is in an open state when a lid of the mixer system is open.

5. The mixer system of claim 1, further comprising a container holder cap configured to constrain a container in the at least one container holder.

6. The mixer system of claim 5, wherein the container holder cap is configured to be fastened to the at least one container holder by sliding a nib of the container first down and then rotated into a slot in the at least one container holder.

7. The mixer system of claim 5, further comprising a first outer spring configured to hold a container insert in place and a second inner spring configured to apply upward force on the container when the container is enclosed within the at least one container holder and the container holder cap.

8. The mixer system of claim 7, wherein the container partially extends through the container holder cap.

9. The mixer system of claim 5, further comprising a plurality of outer springs connected between the container holder cap and the at least on container holder, the plurality of outer springs configured to hold tension on the container holder cap when a container is in the container holder.

10. The mixer system of claim 1, wherein the rotating structure comprises a first main gear around the inside of the rotating structure and a second minor gear around the outside of the at least one container holder, the first main gear and the second minor gear configured to interact such that the rotations of the rotating structure and the at least one container holder are in opposite directions.

11. A method comprising:
providing a rotating structure mechanically coupled to a motor, the rotating structure comprising an outer main gear;
operating the motor such that the rotating structure rotates in a first direction; and
providing at least one container holder mechanically coupled to the rotating structure, the at least one container holder comprising a minor gear, the minor gear configured to interact with the outer main gear such that the at least one container holder rotates in a second direction opposite from the first direction.

12. The method of claim 11, wherein the first direction is clockwise and the second direction is counterclockwise

13. The method of claim 11, further comprising disabling operation of the motor if a safety switch is open, the safety switch comprising an open condition if a lid enclosing the motor and rotating structure is open.

14. The method of claim 11, further comprising constraining a container in the at least one container holder with a container holder cap.

15. The method of claim 14, further comprising holding down the container holder cap with outer springs to provide tension thereto.

16. The method of claim 14, further comprising securing the container holder cap to the container holder by inserting and then rotating a nib of the container holder cap into a slot in the container holder.

17. A system comprising:
means for rotating a structure in a first direction, the rotating structure comprising an outer main gear;
means for rotating at least one container holder mechanically coupled to the rotating structure, the means for rotating the at least one container holder comprising a minor gear, the minor gear configured to interact with the outer main gear such that the at least one container holder rotates in a second direction opposite from the first direction.

18. The system of claim 17, further comprising means for securing a container in the at least one container hold during rotation of the structure.

19. The system of claim 17, further comprising means for disabling the means for rotating the structure if an open condition is present.

20. The system of claim 17, wherein the first direction is clockwise and the second direction is counterclockwise.
